(19) United States
(12) Patent Application Publication
(10) Pub. No.: US 2008/0109347 A1
(43) Pub. Date: May 8, 2008

(54) System and methods for constructing loans

(76) Inventors: John W. Pilcher, New York, NY (US); Christopher Francis Seay, New York, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/507,739

(22) Filed: Aug. 22, 2006

(51) Int. Cl. G06Q 40/00

(52) U.S. Cl. 705/38; 705/35

(57) ABSTRACT

A system and methods for the construction of a loan are provided. In an illustrative implementation, a loan is secured by a first mortgage that may be bifurcated into at least two promissory notes—a senior note and at least one junior, subordinated, Hyper-Note. In an illustrative implementation, the amounts, term maturity, rates of interest, and amortization schedules of the first mortgage loan and the at least two promissory notes can be iteratively determined according to a selected loan construction paradigm. In the illustrative implementation, the selected loan construction paradigm can require that the underlying entire first mortgage loan have an amortization schedule shorter than the resulting senior promissory note such that the resulting junior Hyper-Note receives excess debt service, primarily derived from but not limited to excess amortization paid to the first mortgage loan, to pay interest and principal to the Hyper-Note such that it is materially, or fully, amortized prior to the loan term maturity.

### BACKGROUND

Loans create liquidity in the real estate market and facilitate transactions. The greater variety and availability of capital in the market facilitates efficiencies in terms of lower costs of borrowing and allows for a greater number of transactions to occur than otherwise might be possible. Both the residential and commercial debt markets have benefited from selling pools of loans in the capital markets as fixed income securities to global investors. Prior to the reforms of the residential debt markets that established Fannie Mae and Freddie Mac charters in the 1970's and the growth of commercial mortgage backed securities (“CMBS”) that evolved from the Savings and Loan crisis in the early 1990s; capital was scarce, debt was expensive, and transacting was difficult. Competition and access to capital was limited because there were few lenders with fixed resources who were supplying capital to many borrowers with strong demand. The securitization process, whereby generally homogenous pools of mortgage loans (i.e., mortgage backed securities, aka “MBS” for residential and “CMBS” for commercial) with similar characteristics are converted into manageable fixed income securities, opened up the supply of loan capital from new investors to include fixed bond investors who did not need to understand or be proficient in understanding real estate or mortgage loans. Today residential mortgage loans are easy to secure for average homeowners and their cost is much lower due to increased competition; a direct result of the maturity and acceptance of MBS securities as a fixed income investment for almost 40 years. CMBS has only slightly more than 10 years of history and its loan products are only beginning to enter the fixed income investment community's consciousness as a mainstream investment.

Loans secured by real estate typically come in two forms: residential and commercial. Residential loans are usually secured by a single family home mortgage and are repaid by an individual, or family. The surety of a residential loan is secured by the strength of the personal income generated by the individual or family. Residential loans are personally recourse to the borrower in that they are guaranteed; the lender has rights to all other assets of the borrower. Commercial loans are secured by the real estate interest in income producing properties such as office buildings, shopping centers, apartment complexes, industrial parks, and hotels. The surety of a commercial loan is secured by the strength of the property's ability to generate income from tenants or hotel guests. Commercial loans can be recourse to the owner of the property but are frequently only secured by the real estate.

Commercial loans are typically either stable or transitory in nature. Income producing properties that are fully occupied and have optimized their cash flow potential usually receive longer term (e.g., 10 years) stable loans with fixed interest rates and mortgage payments. Transitory loans are more likely to be provided for newly constructed properties or buildings that are not well leased. These loans are short term in nature (e.g., 3 years) and typically have adjustable rates. An owner's investment plan as well as a property's condition, are two primary variables employed to determine the type of loan s/he secures.

Commercial loans can be constructed in a variety of ways to satisfy similar or competing interests. From the supply side, the loan provider generally seeks to construct loans that maximize their return, in the form of an interest rate, while mitigating the risk of loan default and loss potential. In commercial real estate, where loans are secured by income producing properties (e.g., office buildings, shopping centers, apartments, hotels, etc.), risk and loss potential are primarily mitigated by a number of factors including but not limited to the strength of a property's income, the size of the loan relative to a property's value, the coverage differential between property's net income and mortgage loan payment, and the speed with which the loan is repaid (i.e., amortization schedule).

On the demand side, borrowers can have various objectives depending on their varied business and personal needs. For example, a publicly traded REIT (Real Estate Investment Trust) can often seek a low leverage, low interest, loan that is less than 65% of a property's value since REITs are generally prohibited from obtaining high leverage loans and since REITs seek to maximize cash flow—available to pay shareholders—after debt service. Comparatively, many private entrepreneurs seek maximum leverage (e.g., a loan used to purchase an office building) to reduce how much equity s/he has to provide, and therefore have a lower exposure to risk, in a given transaction to acquire a property. Alternatively, in a refinance transaction, maximum loan requests are often a way to return profits to an owner without selling the asset. Borrowers who are interested in owning an asset for the cash flow after debt service returns, such as the REIT owner, are typically concerned with having as low a debt service payment as possible. A borrower's business decisions can be often driven by a loan's interest rate and amortization schedule.

In contrast, borrowers who are primarily focused on the capital gains returns related to a property's appreciation in value and who seek to reduce their monetary exposure to a given property are typically interested in obtaining the largest available loan. The business decisions of these types of borrowers are often single-minded in nature and can be driven by the answer to the question: “how much can s/he borrow by pledging the property's entire cash flow?” Amortization and interest rates are typically secondary considerations for “maximum loan” borrowers because they generally presume that a lender will require all of a property's cash flow for the highest leverage loans. The REIT and “maximum loan” borrowers represent two extreme examples but there are many shades of commercial real estate entrepreneur in between. The choice of investment objectives can be directed by market conditions such as interest rates and by other market forces.

A loan used in the purchase of real-estate is represented by an underlying security called a mortgage. The mortgage (which is a temporary, conditional pledge of property to a creditor as security for performance of an obligation or repayment of a debt) is generally associated with one or more promissory notes which are agreements between the lender and the borrower describing the parameters for the loan—e.g., loan amount(s), loan term(s), interest rate, amortization schedule(s), etc. The loan can be constructed according to one or more loan paradigms that provide one or more loan parameters. For example, a loan for the purchase of a commercial property can be for 85% of the purchase price and can be comprised of one first mortgage loan that is bifurcated into two unequal promissory notes. It is common for such a mortgage loan to have a large senior note (“Senior Note”) and a small junior note (“Junior Note”). Both notes retain a first mortgage interest in the real estate but the Junior Note is subordinate to the Senior Note, therefore, losses accrue to the Junior Note primarily and rights of foreclosure, and to cash flow, accrue to the Senior Note primarily.

On a high leverage loan, typically a market standard whole first mortgage loan or a Senior Note can be up to 80% loan to purchase/value (termed “LTV” for Loan To Value) and will have a cash flow-to-mortgage-payment ratio of at least 1.20:1 (called a “DSCR” for “Debt Service Coverage Ratio”). Generally, the Junior Note can represent an amount equal to the difference between the value of the Senior Note and up to 89% LTV and will not have a DSCR of less than 1.01:1. In a typical transaction, the Senior Note lender and the Junior Note lender are subject to a single loan agreement with the borrower. So long as the underlying loan agreement provides for lender to have the right to split the loan into two or more notes the lender may split the loan, subject to whatever restrictions the loan agreement might require, and, if lender so chooses, may sell one or all promissory notes subject to a negotiated inter-creditor agreement that will govern the note holder's rights. It is common for loan agreements sold in the capital markets (i.e. CMBS) to include this right with few substantive restrictions.

The current market loan paradigm for commercial first mortgage loans split into a senior note and a junior note structure is commonly called an “A-Note” and a “B-Note” respectively. The notes are close resemblances to the combined loan with nearly identical prorata cash flow, debt service, amortization, terms and balloon balance loan/note parameters. As currently constructed the market paradigm primarily differentiates the seniority of priority of payment and interest paid to the two notes. A typical market example of this structure would be for an $8.5 million loan with an interest rate of 1.45% plus the 10 year treasury index (e.g. 1.45%+5.00% 10YT=6.45% interest rate) and a 10 year term with a 30 year amortization schedule to be split into a “A-Note” of $8.0 million with an interest rate of 1.10% plus the 10 year treasury index (e.g. 1.10%+5.00% 10YT=6.10% interest rate) and a 10 year term with a 30 year amortization schedule and a $500,000 B-Note with an interest rate of 7.0% over the 10 year treasury index (e.g. 7.00%+5.00% 10YT=12.0% interest rate) and a 10 year term with a 30 year amortization schedule. Under such a loan paradigm the weighted average interest rate of the two notes, net of the 10 year treasury index (i.e. 1.10%*$8.0M & 7.0%*$0.5M=1.45% on $8.5M), is equal to the interest charged on the whole loan. The amortization of each note and on the loan are usually all on the same schedule (i.e. 30 years) therefore the loan parameters, and the risks associated with each note, are nearly identical to those of the whole loan. The primary differentiation between the notes and the loan under the current market paradigm is the subordination of the B-Note to the A-Note, which does increase the severity risk of losses to the junior “B” promissory note. The level of interest provided to the B-Note holder (i.e. 12%) typically corresponds with the higher the risk such that on a 50% LTV (low risk) loan the interest might be as low as 3.50% over the 10 year treasury index. Where no seniority between notes exists, often termed as notes being paid on a “pari passu” basis, the interest rates of both notes would typically be equal to each other and the loan, all other terms and parameters being equal. It is possible, and not uncommon, under the current paradigm to require no amortization under the B-Note or A-Note, however, this added risk to the B-Note is not offset by loan structure to the A-Note but rather by a higher interest charge to the junior promissory note.

An alternative high leverage loan paradigm would consist of a loan equal to 85% of a property's purchase price, as an example, in the form of an 80% first mortgage loan and a 5% subordinate mezzanine loan. Unlike the A/B first mortgage note structure above, the mezzanine loan is subject to a separate loan agreement and does not have a direct interest in the property. Rather the mezzanine loan is secured by the owner's equity interest in the property. Second mortgages, with a direct interest in the real estate and rights of foreclosure are similarly available but rare due to the reluctance of first mortgage loan holders to allow junior loan lenders such expansive rights. The junior loans or notes that are subordinate to the senior loans typically have a similar structure and payment type to the senior loans, as was described above in the A/B Note. That is, fixed rate senior loans typically will have fixed rate junior, or mezzanine, loans/notes, loan terms of the senior and junior notes, or mezzanine loans, tend to be the same, and amortization schedules of the junior and senior notes tend to be aligned.

Lenders, and their investors, charge an interest rate and require a yield return that is risk adjusted for the loan's probability of default and loss severity profile. High leverage loans, where an owner has little of his/her equity invested in a property, are inherently more risky than low leverage loans. Consequently lenders seek a higher than typical interest rate as compensation for that risk. The risk can be measured by: 1) a loan's probability that it will default and; 2) the loss potential (i.e. severity) in the event that the borrower defaults on the loan.

The probability of a loan defaulting can be impacted by a number of factors. In commercial real estate, how low a loans' DSCR is to 1.0:1.0, or below, as well as how stable a property's revenue are, often highly correlate to the likelihood of default. Where the probability of default for a first mortgage loan holder is directly related to how large the last dollar of the loan is, the amount of the losses (i.e., severity) depends on the cause of the default and how much value the property has lost, at the time of default. Where default occurs as a technicality—i.e. value remains intact—the lender can foreclose and sell the property to make the loan's holders whole or, potentially even make a profit. In contrast, as an example, where a grocery store declares bankruptcy and the owner of the shopping center is forced to sell his property at a loss, the lenders' loss is equal to the amount of proceeds collected from the sale minus the combined outstanding loan balances. All losses affect the most subordinate mortgage loan or note holder first, therefore, where loss default affects all lenders equally (i.e. default on any note is a default on the entire loan). However, loss severity affects junior “B” note holders (e.g., B-Note, mezzanine loan, and second mortgage holders) disproportionately.

A loans risk can also be differentiated by term risk and balloon risk. Term risk can be considered as the risk that a loan defaults during a loan term. The term risk of a loan to the lender, or the mortgage holder, is directly impacted by the length of a loan's term and any exogenous factor that could stress the property's (where a property is used to secure a loan) ability to generate revenue or reduce net income available to pay debt service. For stable, fixed rate loans, term risk is not affected by interest rates because the mortgage payment is constant and regular through the term. Transitory, or floating rate, loans, however, have mortgage payments that rise and fall with interest rates, therefore, term risk rises with the increase in the cost to the loan from higher interest rates. In a certain cases term risk can be mitigated almost in its entirety—e.g., a loan to an office building owner that has leased the property to the U.S. government for a lease term that is longer than the loan term.

Balloon risk can be considered as the risk that a loan defaults and causes loss at the end of a loan term because it is unable to be repaid in full via refinance or sale. High interest rates, low market rents, an increase in available supply, constricted debt liquidity, and a low risk tolerance from prospective investors can heavily increase the balloon risk of a loan and are beyond the control, or knowledge, of the borrower and lender at the time of loan origination. The loan provider can use amortization to offset balloon risk by lowering the loan's principal balance over the loan term such that the “balloon”, or required repayment is lower at the end of the loan term. Such amortization can act to reduce the probability of loan default because it makes it easier for another future lender to refinance the loan or the borrower to sell the property. Furthermore, a lower balloon balance can reduce loss severity by creating a greater equity gap between a property's initial value and its last (highest) dollar of debt. Loans that self-amortize can be considered to have zero balloon risk.

Expectations theory is a commonly held theory of finance and valuation where, all things being equal, an investment with a shorter average life can be considered more valuable. Put another way, in a positive growth economy, an investor's expectation for return will be higher where s/he is asked to have his investment locked up for a longer period of time. Where an investor is offered the same annual return for a 2 year investment as a 10 year investment s/he would accept the 2 year investment if s/he believes that equal or higher returns are more likely in 2 years than not. An illustration of this principle is the U.S. Treasury yield curve where a 30 year government bonds typically offer substantially higher yields than 2 year bonds. For bond investors or investors in pools of mortgages (i.e., MBS or CMBS) the investors' required return is lower for shorter bond classes than longer bond classes. For this reason, or where the returns are the same for both the shorter and longer bond classes, investors will typically be willing to pay a higher price for the shorter paper than the longer paper. Fixed income investors typically measure this in terms of weighted average life and in the duration of an asset (i.e. McCauley Duration).

From the foregoing, it is appreciated that there exists a need for systems and methods that construct loans according to a selected paradigm allowing lenders to reduce their risk exposure and facilitate a greater number of transactions, while allowing borrowers to benefit from lower interest charges and reduced balloon payments.

### SUMMARY

Systems and methods are provided for constructing loans according to a selected loan paradigm. In an illustrative implementation a loan construction platform is provided comprising a loan construction engine. In the illustrative implementation, the loan construction engine comprises one or more instructions sets to instruct the loan construction engine to generate loans according to a selected loan paradigm.

In an illustrative operation, the selected loan paradigm can comprise one or more loan parameters that construct loans represented by one first mortgage loan having at least two promissory notes. In the illustrative operation, the first of the at least two promissory notes can be senior (the “Senior Note”) in priority of payment to the other of the at least two junior, or subordinated, promissory notes (described herein as a “Hyper-Note(s)”). In the illustrative operation, the selected loan paradigm can comprise one or more loan parameters directing the terms of the mortgage loan, the Hyper-Note promissory note(s), and the senior promissory note such that the loan term dates (i.e. date of repayment) of the mortgage loan and Senior Note are commensurate and equal.

Further, in an illustrative operation, the mortgage loan, the Hyper-Note(s), and the Senior promissory Note can be selected to have different amortization schedules where the Senior Note's amortization schedule is longer than the underlying whole mortgage loan and the Hyper-Note(s)' amortization schedule is selected in conjunction with the term and/or amortization schedule of the Senior note so that the Hyper-Note is effectively paid to zero before the term expires on the Senior Note and the underlying mortgage loan.

Other illustrative features and operations of the herein described systems and methods are further described below.

### BRIEF DESCRIPTION OF THE DRAWINGS

The systems and methods for loan construction are further described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a block diagram showing the cooperation of exemplary components of another illustrative implementation in accordance with the herein described systems and methods;

FIG. 4 is a block diagram showing an illustrative block representation of an illustrative mortgage loan re-amortization and management system in accordance with the herein described systems and methods;

FIG. 5 is flow diagram showing illustrative processing performed when constructing loans in accordance with the herein described systems and methods; and

FIG. 6 is block diagram showing an exemplary implementation of the loan construction processing in accordance with the herein described systems and methods.

FIG. 7 is block diagram showing exemplary annual cash flow schedules & balances, with an accompanying graphic chart, in accordance with the herein described systems & methods.

### DETAILED DESCRIPTION

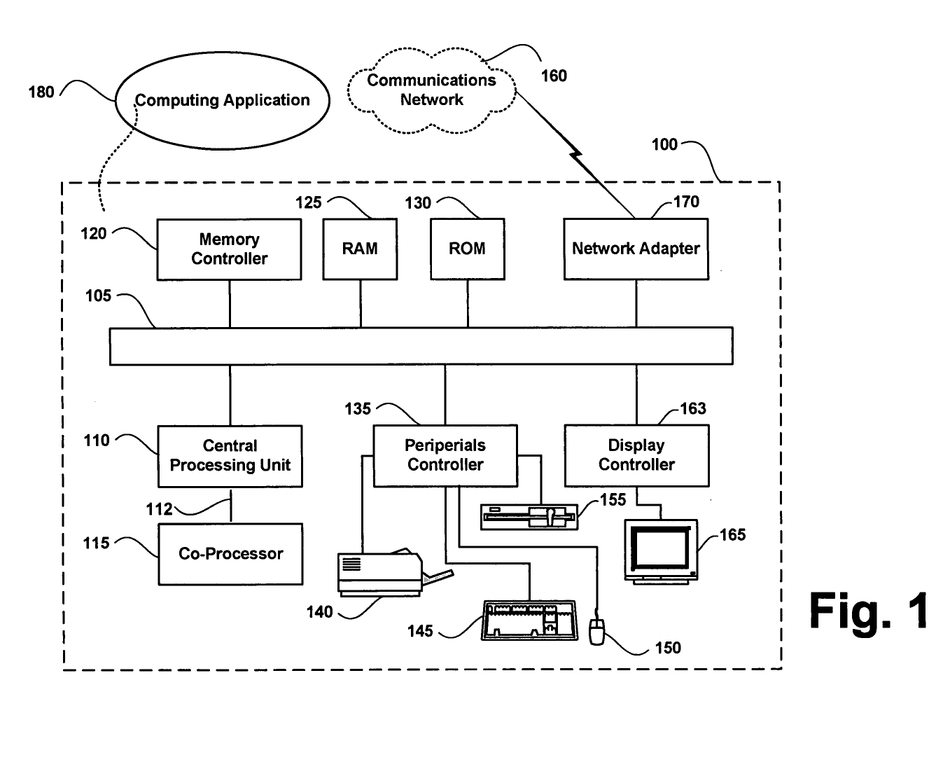

FIG. 1 depicts an exemplary computing system 100 in accordance with herein described system and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communication network 160.

### Illustrative Computer Network Environment:

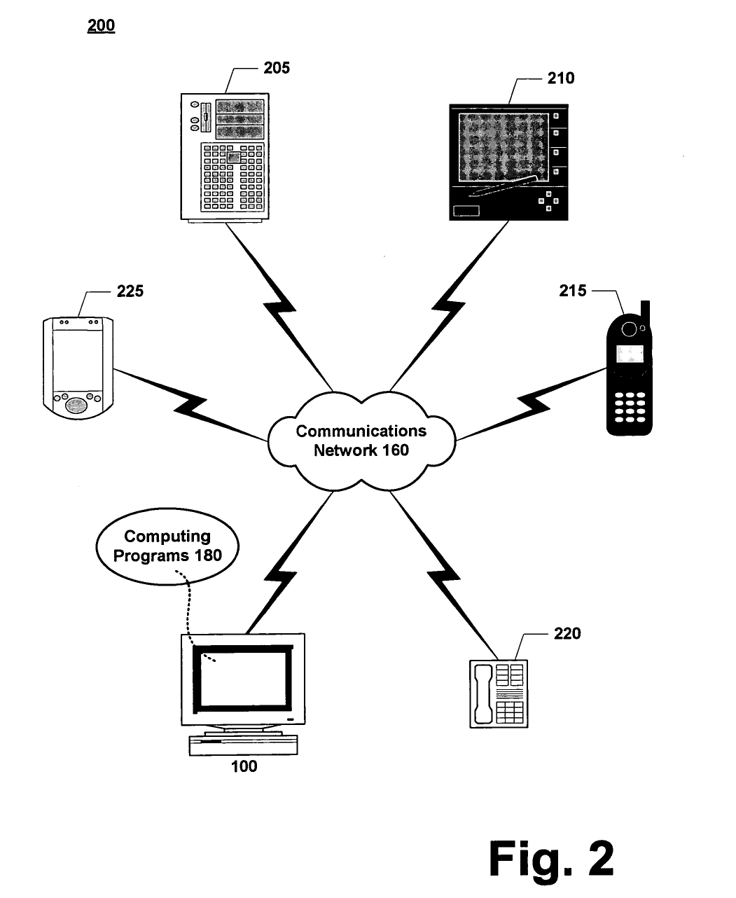

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication of executables and/or data and may cooperate with other server computing environments (not shown), third party service providers (not shown), network attached storage (NAS) and storage area networks (SAN) to realize such communication of executables and/or data.

### Loan Construction Overview:

The herein described systems and methods provide for the construction of a loan according to a selected paradigm. In an illustrative implementation, a single whole first mortgage loan can be structured such that it is bifurcated into a junior promissory note(s) (to be described hereafter as a “Hyper-Note(s)”), and a senior promissory note (the “Senior Note”). In the illustrative implementation, the Hyper-Note(s) can have a loan parameter such that the Hyper-Note(s) does (do) not maintain a balloon balance. Characteristically, the Hyper-Note(s), in the illustrative implementation, may be relatively small, compared with either the total property value (e.g., value of property used to secure the loan) or the mortgage loan such that cash flow distribution from the property that is used to make the single first mortgage loan payment can be bifurcated to make a market-normal debt service payment to the Senior Note and use the residual monies from the underlying mortgage loan to substantially pay off the Hyper-Note(s) (e.g., pay off the Hyper-Note(s) to a substantial degree prior to the term expiration set on the Senior promissory Note). In effect, a greater than pro-rata proportion of amortization paid from the borrower's debt service on the combined first mortgage loan is used as additional interest or principal to pay down the comparatively small junior Hyper-Note(s) more quickly than current market loan constructions allow. This will result in a Senior Note with a longer amortization schedule than, and an equal balloon balance compared to, that of the combined first mortgage loan.

By way of example, a borrower can request a loan in the amount of $8.5 MM to purchase an office building having a purchase price of $10.0 MM. Given a common market loan paradigm, senior loan lenders are typically prohibited from providing a senior loan of more than 80% of a property's value (i.e. purchase price). As such, a typical senior lender is only be willing to provide an $8.0 MM loan. Such a borrower would, with typical current market practices, be able to secure a $0.5 MM mezzanine loan or comparable senior-junior combined $8.5 MM mortgage loan wherein the marginal $0.5 MM loan dollars have amortization schedules that are equal to or greater (i.e. longer) than both the senior note and the first mortgage loan. The junior note, senior note and the underlying mortgage loan, in most current market paradigms, have identical terms and amortization schedules. The marginal cost, in terms of interest rate, for each additional loan dollar above the senior loan ($0.5 MM) is typically greater than 12.0%. The high cost of interest can act to compensate the junior note holders for the substantial risk of the note, particularly of the note's balloon risk as described previously. The senior note, too, typically incurs a small additional cost where a mezzanine loan or junior note is created. Such cost can be passed on to a borrower in the form of a higher interest rate because the marginal increase in debt stresses the property and increases the probability of default throughout the term and, in particular, at the end of the term due to increased refinance risk (i.e., balloon risk).

The herein described systems and methods ameliorate the shortcomings of existing practice. According to an implementation of the herein described systems and methods, using the above example, an $8.5 MM first mortgage can be provided in such a way as to reduce the cost of the marginal loan dollars substantially, vis-à-vis the elimination of many loan risk characteristics, to the junior note—which is unique and described hereafter as a “Hyper-Note”—as well as to the senior note, thereby creating substantial value in the marketplace that can then be passed on to the borrower in the form of lower overall interest rates or the Hyper-Note owner/investor in the form of a better value/price. Such a loan paradigm, where the borrower receives an $8.5 MM loan with a selected loan term (e.g., 10 year term) and a selected debt service schedule based on a amortization schedule (e.g., 26 year amortization schedule) can act to bifurcate the first mortgage loan into an $8.0 MM senior note, with a selected term (e.g. 10 year term) and a second selected debt service payment based on a second selected amortization schedule (e.g., 30 year schedule) and a $0.5 MM Hyper-Note loan that amortizes to $0 before the selected term (e.g., 10 years, or more specifically, around 118 months). The shorter mortgage loan selected debt service schedule based on the selected amortization schedule (e.g., 26 year amortization schedule) on the entire $8.5 MM mortgage loan requires a higher overall mortgage payment than if it were, as market standards currently offer, to amortize over the second selected amortization schedule (e.g., 30 years). In the illustrative implementation, the difference in debt service payments between the selected amortization schedule and the second selected debt service schedule can be used as either interest or principal to liquidate, or hyperamortize, the Hyper-Note to zero or a financially insignificant end balance. And end balance, or balloon balance, which the herein described systems and methods eliminate or reduce, can be cause for increased risk to the mortgage loan and, therefore, can be a source for the marginal increased cost to the borrower. The selected note terms and note amortization schedules, as well as how principal and interest are distributed within the first mortgage loan to the notes, will typically be transparent to the borrower.

As an additional loan paradigm within the same construct in the illustrative implementation it is possible to structure a similarly small (i.e. $0.5 MM) and self-liquidating Hyper-Note, as described above, by taking amortization otherwise scheduled for the Senior Note, instead of from the whole first mortgage loan. As an example of such a loan paradigm where the selected amortization schedule of 30 years can act to bifurcate the first mortgage loan into an $8.0 MM Senior Note, with a selected term (e.g. 10 year term) and a second selected debt service payment based on a custom second selected amortization schedule (e.g. 30 years after 5 years of interest only) resulting in a $0.5 MM Hyper-Note that amortizes to $0 before the selected term. The described loan paradigm effectively shifts amortization payments normally due, under current market standard bifurcated first mortgage loans, to the Senior Note holder in the first 5 years of the selected term to the subordinated Hyper-Note holder, where risk is most acute. The two paradigms of the illustrated loan construct in both cases require a market standard first mortgage loan that is bifurcated into at least one market standard Senior (promissory) Note, with a longer amortization schedule (e.g. 30 years or none for 5 years then 30 years thereafter) and a similar term (e.g. 10 years) as the whole first mortgage loan (e.g. 26 years or 30 years), and at least one Hyper-Note (i.e. junior promissory note) that hyperamortizes to zero, or nearly zero, by the loan term (e.g. 10 years).

Further in the illustrative implementation, the repayment of the Hyper-Note can result from structuring additional amortization in the combined, underlying, first mortgage loan such that the residual cash flows can be directed to the Hyper-Note repayment after having paid the “normal” (e.g., market accepted amortization schedule—30 years) amortization schedule of the Senior Note. In the illustrative implementation, the result of the loan structure can be to reduce the overall amount of interest paid under the loan. That is, principal payments reduce the outstanding debt—the most costly portion of debt (the subordinated junior promissory Hyper-Note)—such that faster principal repayment reduces the balance more quickly, which then reduces the amount of interest paid over the loan term. Therefore, by way of the presented illustrative implementation and example, where all other terms are equal, over a 10 year term a borrower will pay less cumulative interest under the herein described loan system than a market standard senior-junior bifurcated loan with exactly the same first mortgage loan terms.

In the illustrative implementation, the loan construct described herein can be more valuable to some borrowers than currently available market loan constructs to others. Borrowers who require significant cash flows after debt service to pay returns or dividends to partners or investors (i.e. REITs) can be less likely to find the loan construct herein attractive. In contrast, borrowers who are willing to trade off excess cash flow after debt service from the property for more loan proceeds—whether to reduce their equity exposure or to close a loan that for any number of reasons requires additional proceeds such that a borrower is unwilling or unable to fund more equity—will consider this loan construct valuable. As a function of how capital markets based senior loan lenders calculate the size of the loans they are willing to provide, a borrower seeking to borrow enough proceeds to require a mezzanine loan, a junior note, or a junior Hyper-Note, by definition, can be required (e.g., by the lenders) to pledge residual cash flow from the property (e.g., possibly all residual cash flow).

In the illustrative implementation, each of the individual senior and junior Hyper-Notes can be more valuable separately than the current market standard equivalent. The senior note no longer is required, as with conventional practices, to carry added costs related to the increase in the probability of default at balloon that is associated with a junior note balloon because under the illustrative loan construct of the herein described systems and methods, the senior note balloon payment is the only balloon payment in the loan construct. Such feature can directly reduce the costs to the large senior note and lower the cost of interest to the borrower ergo it has more value. Furthermore, with the herein described illustrative implementation, a self-liquidating structure of the Hyper-note is more valuable than its slow-amortizing market comparable junior note to many investors in the fixed income investment market because while the note receives the same interest rate, and yield, it benefits from significantly reduced risk characteristics: zero refinance risk, no interest rate risk, and has a shorter average life and duration.

The lower duration and significant risk mitigating factors can make the junior Hyper-Notes of the herein described systems and methods, where all else is equal, more valuable to the holder. Quantifiably, one way this value can be measured is vis-à-vis the reinvestment premium. The reinvestment premium is the amount of returns an investor can generate from the returned principal that is paid more quickly under the illustrated loan construct than under current market standard loan constructs. On average, only 15% of a market standard junior note (i.e. b-note or mezzanine loan) loan balance is re-paid over a typical 10 year loan term. Under the illustrated loan construct, 100% (or an amount large enough to be financially equivalent) of the junior Hyper-Note is returned within the loan term and returned quickly such that the note holder can then use the accretive returned principal to reinvest into other investments. In effect, where both a market junior b-note that amortizes over 30 years and a junior Hyper-Note that fully amortizes over 10 years, of the same size that receive identical interest rates (i.e. 12.5%) and yields on the notes, the owner of the Hyper-Note can reinvest a substantially greater proportion of their returns in similar or higher returning investments over the same 120 month investment period. In this way an investor can make his/her portfolio to current market terms and benefit from changes and growth in the market. As an example, comparing a junior b-note and a junior Hyper-Note over 10 years where each receives a 12.5% rate of interest and where the b-note amortizes over a 30 year schedule and the Hyper-Note is fully repaid by the 118^{th} month; both notes achieve approximately 12.5% yields on their initial investment over 120 months.

Another way the illustrated loan construct demonstrates unique value is by reducing the investor's risk exposure for the same interest rate. Under the illustrated loan construct a typical weighted average life of a 10 year junior Hyper-Note with an identical interest rate to a market b-note would be 5.7 years compared to a typical market weighted average life of 9.4 years. The junior Hyper-Note holder, in the illustrated implementation, can therefore effectively more quickly achieve the breakeven point (i.e., the point where an investor has received a “return of” their initial principal investment) substantially faster than under current market loan constructs and paradigms. More importantly the junior Hyper-Note holder, in accordance with the herein described systems and methods, is scheduled to receive their profits and principal investment before the term of the loan without condition of further repayment vis-à-vis a required sale of the property or refinancing that must be subject to uncontrollable exogenous factors such as determined by real estate markets, interest rates, capital liquidity, and borrower performance, to name only a few.

In an illustrative operation, where such a loan construct system, as herein described, generates a Senior Note and a junior Hyper-Note that are individually more valuable than their market “normal” b-note, or mezzanine loan, counterparts, then collectively the underlying mortgage as a sum of the parts can be considered to be more valuable as the individual expected value from the impending bifurcation process is passed to the mortgagee. These cost efficiencies can be passed on to the borrower in the form of lower interest rates, or more loan dollars, on the combined underlying mortgage. In this way then the market is enhanced by the addition of the illustrated loan construct and it is likely that more transactions will be completed, and greater value created, that otherwise would not have been. As an example, current market normal lender interest rates might charge 1.15% over the 10 year US Treasury bond (e.g., 4.75% 10Y UST+1.15%=5.90% interest rate) for a standard first mortgage with no bifurcated note or additional subordinated debt. Adding a market standard $0.5 MM junior b-note on top of an $8.0 MM senior note could typically require a 0.10% add-on (i.e. 5.90% interest rate+0.10% add on=6.00% rate) to the $8.0 MM senior note, for the added risk of having a junior-note behind the senior note. The blended interest rate assuming a marginal interest charge of 12.0% on the junior note dollars would then result in a 6.35% interest rate on the full $8.5 MM mortgage (i.e., $8.0 MM @ 6.00% and $0.50 MM @ 12.0%=$8.5 MM (6.35%). Under the loan construct system described herein, however, it is not unreasonable for the add-on charge to the senior note, where a junior Hyper-note exists, to be reduced from 0.10% to 0.05% and the Hyper-Note interest rate to be substantially lowered (e.g., 9.0%) due to its reduced risk profile related to shorter duration, weighted average life, lack of balloon, and ability to allow compounded returns on returned principal. The blended interest rate for such a loan paradigm would be 6.13% (i.e., $8.0 MM @ 4.75% 10Y UST+1.15%+0.05%=5.95% rate on senior note and $0.50 MM @ 9.0% on the junior note) on the total $8.5 MM first mortgage loan. Therefore, by employing a new the loan construct in accordance with the herein described systems and methods, a borrower can receive a rate of 6.13%, equating to a 0.22% rate benefit compared with current market standards, where the borrower's only marginal concession has been to accept a shorter amortization schedule (e.g. 26 years) versus a typical market standard 30 year amortization schedule on their first mortgage loan.

Lower rates on high leverage mortgages create value in the real estate marketplace not only by lowering borrowers cost but by making it more attractive for lenders to provide liquidity on the highly leveraged transactions.

### Loan Construction Computing Environment:

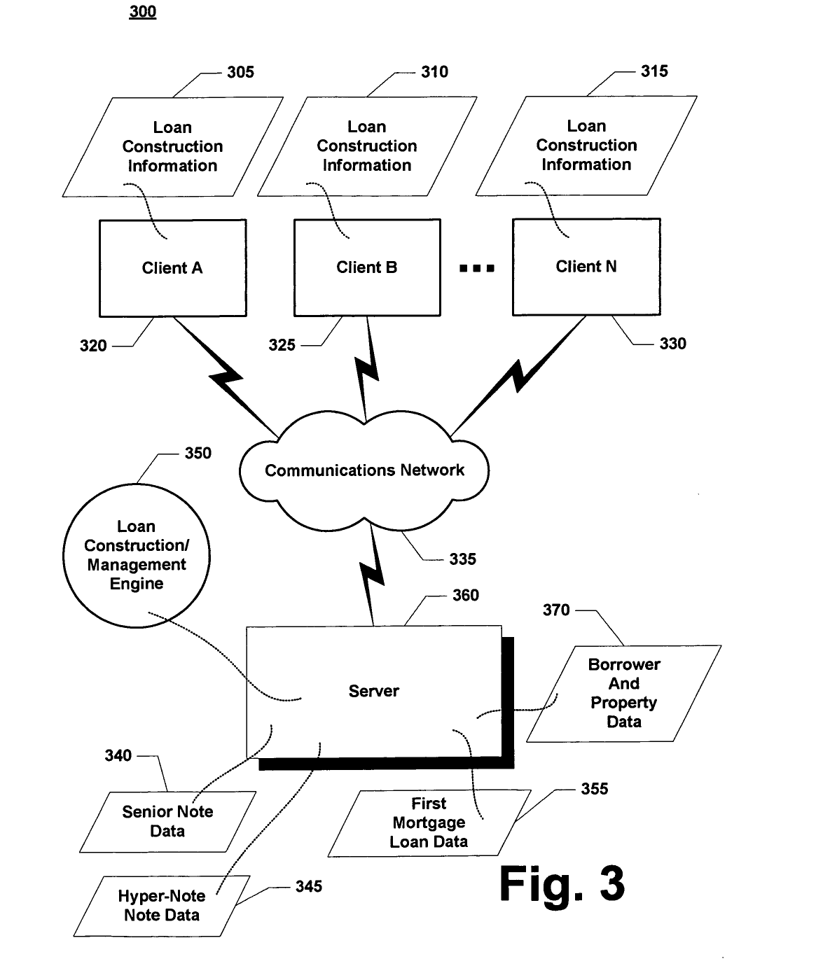

FIG. 3 shows an illustrative implementation of exemplary loan construction and management platform 300. As is shown in FIG. 3, exemplary loan construction platform 300 comprises client computing environment 320, client computing environment 325 up to and including client computing environment 330, communications network 335, server computing environment 360, loan construction/management engine 350, senior note data 340, Hyper-Note data 345, (whole) first mortgage loan data 355, borrower equity and property data 370. Also, as is shown in FIG. 3, loan construction/management platform can comprise a plurality of generated loan construction information 305, 310, and 315 which can be displayed, viewed, electronically transmitted and printed from client computing environments 320, 325, and 330, respectively.

In an illustrative operation, client computing environments 320, 325, and 330 can communicate with server computing environment 360 over communications network 335 to provide requests for and receive loan construction information 305, 310, and 315. In the illustrative operation, loan construction/management engine 350 can operate on server computing environment 360 to provide one or more instructions to server computing environment 360 to process requests for loan construction information 305, 310, and 315 and to provide loan construction information 305, 310, and 315 to the requesting client computing environment (e.g., client computing environment 320, client computing environment 325, or client computing environment 335). As part of processing requests for loan construction information 305, 310, and 315, loan construction/management engine 350 can utilize a plurality of data including senior note 340, Hyper-Note data 345, and borrower equity and property data 370. Also, as is shown in FIG. 3, client computing environments 320, 325, and 330 are capable of processing loan construction information 305, 310, and 315 for display and interaction to one or more participating users (not shown).

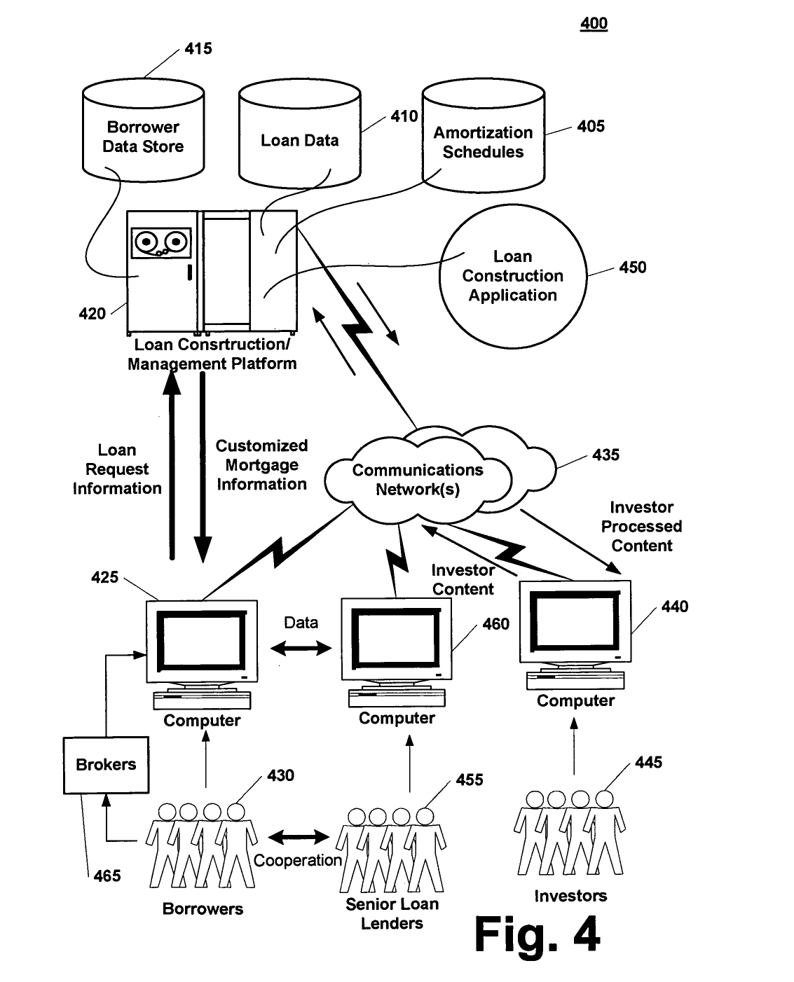

FIG. 4 shows a detailed illustrative implementation of exemplary loan construction/management environment 400. As is shown in FIG. 4, exemplary loan construction/management environment 400 comprises loan construction/management platform 420, borrower data store 415, loan data store 410, and amortization schedules data store 405, communications network 435, user computing environment 425, borrowers 430, investor computing environment 440, and investors 445. Additionally, as is shown in FIG. 4, loan construction and management environment 400 can comprise loan construction application operable on loan construction/management platform 420 to provide loan construction/management platform one or more instructions for the construction of a loan according to a selected loan paradigm (not shown). The selected loan paradigm can comprises one or more parameters (not shown) to direct the construction of a first mortgage loan being bifurcated into at least two promissory notes, where at least one note is senior in priority of payment, such that the amortization schedules of the combined mortgage loan, the senior note, and the junior Hyper-Note(s) are each unique and they allow for the full, or nearly full, repayment of principal or the Hyper-Note(s) during the stated term of the senior note.

In an illustrative implementation, loan construction/management platform 420 can be electronically coupled to user computing environment 425 and investor computing environment 440 via communications network 435. In the illustrative implementation, communications network can comprise fixed-wire and/or wireless intranets, extranets, and the Internet.

In an illustrative operation, borrowers 430 can interact with an exemplary loan construction/management user interface (not shown) operating on user computing environment 425 to provide loan request information that can be passed, directly or via brokers 465, across communications network 435 via computer 425 to loan construction/management platform 420. Alternatively, the borrowers 430 or brokers 465 may use the user computing environment 425 to submit loan request information to senior loan lenders 455 to be passed across communications network 460 to loan construction/management platform 420. In the illustrative operation, loan construction/management platform 420 can process loan request information requests according to one or more instructions provided by loan construction application 450 and cooperate with borrower store 415, loan data store 410, and amortization schedule data store 405 to construct loans (not shown) for consideration by borrowers 430, senior loan lenders 455, and investors 445.

In an illustrative operation, senior loan lenders 455 can interact with an exemplary loan construction/management user interface (not shown) operating on user computing environment 460 to provide loan purchase requirement information that can be passed across communications network 435 to loan construction/management platform 420. In the illustrative operation, loan construction/management platform 420 can process loan purchase requirement request information requests according to one or more instructions provided by loan construction application 450 and cooperate with borrower store 415, loan data store 410, and amortization schedule data store 405 to purchase individual senior notes or pools of senior notes for consideration by borrowers 430, senior loan lenders 455, and investors 445.

In an illustrative operation, investors 445 can interact with an exemplary loan construction/management user interface (not shown) operating on user computing environment 440 to provide investment requirement information that can be passed across communications network 435 to loan construction/management platform 420. In the illustrative operation, loan construction/management platform 420 can process investment request information requests according to one or more instructions provided by loan construction application 450 and cooperate with borrower store 415, loan data store 410, and amortization schedule data store 405 to purchase individual junior Hyper-Notes, pools of Hyper-Notes, or an interest in an issued security collateralized by Hyper-Notes (not shown) for consideration by borrowers 430, senior loan lenders 455, and investors 445.

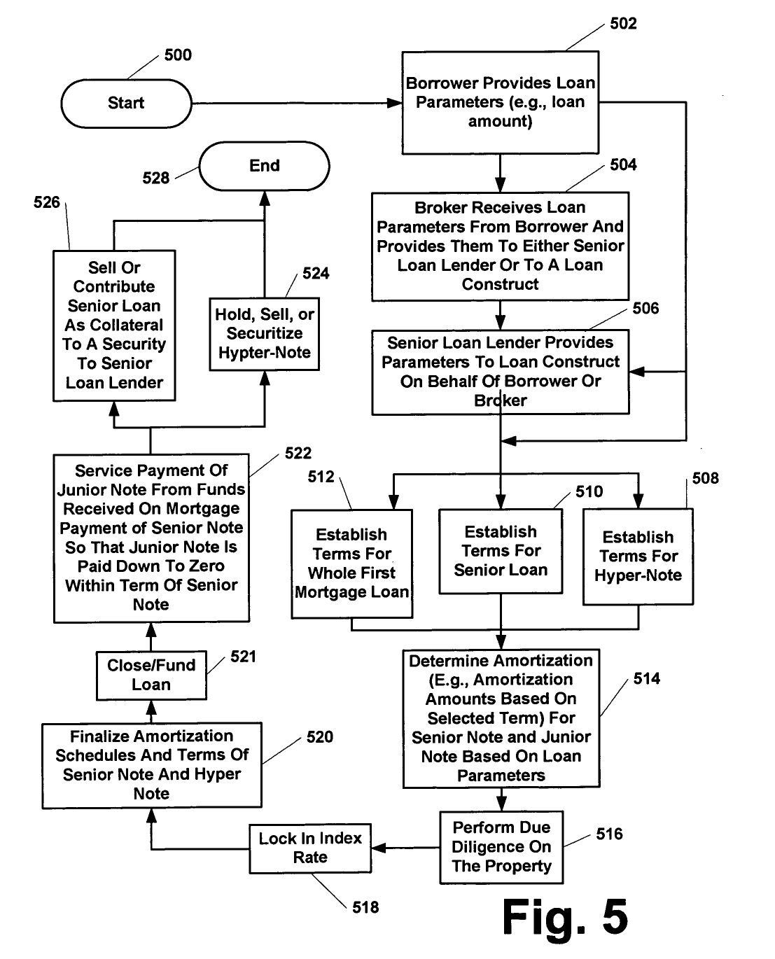

FIG. 5 shows exemplary processing performed by loan construction environment 400 of FIG. 4. As is shown processing begins at block 500 and proceeds to block 502 where a borrower provides loan characteristics for processing in constructing an appropriate loan. Such loan parameters can include but are not limited to, loan amount, purpose of loan (refinance or acquisition), term, fixed or floating rate, purchase price, etc. From there, processing proceeds to either: broker 504; senior loan lender 506; or directly to block 510 where the mortgage loan is constructed according to the loan parameters. If directed to broker 504 or the senior loan lender 506 processing will proceed to blocks 508, 510, and 512 either directly or from broker 507 through the senior loan lender 506 as an intermediary. In constructing the loan per the borrower's requested terms, the loan is represented by a first mortgage loan per terms determined at block 514. Simultaneously, the amount, interest rate, loan term, profit, and requested additional terms of the whole first mortgage loan and each varied note, according the relevant party's needs is determined simultaneously at block 516, 518, 520, and 522 via an iterative process.

Processing at block 516 is where the initial, preliminary, amortization schedule, term, interest rate, and other relevant loan terms for the first whole mortgage loan can be solved for, in an illustrative implementation by: a) matching the balloon balances of the first mortgage loan with the senior note via processes that occur at block 514 and b) ensuring the Hyper-Note(s) amortizes to zero, or nearly zero, prior to the loan term at processes that occur at block 520 (and 525), while achieving the required loan amount, interest rate, profit or need, to simultaneously satisfy each party. As was previously described in order for the Hyper-Note(s) to fully amortize and be profitable, as determined at block 520, after the index interest rate has been locked at 518, the senior notes amortization schedule will be longer than the (whole) first mortgage loan, as initially determined at block 514 and confirmed at block 520.

After preliminary loan terms are agreed to between parties at 514 the process will move to block 516 where the loan documents are derived and due diligence is performed to determine the value, condition, and legal standing, of the collateral securing the first mortgage loan and the respective underlying notes. In an illustrative implementation, the loan documents can provide that lender has the right to split the first mortgage loan, and its subsequent mortgage loan payments, into two or more notes. The senior loan lender may, or may not, be involved at this stage of the processes; due to the formulaic nature of capital markets based senior loan lending programs and the predictability of their requirements it is just as often that the senior promissory note will be structured in absentia and sold, auction style, at block 526. During or after the processes at block 516, where the property is being evaluated a significant portion of the interest rate will be locked by selling US Treasuries (518) of a duration matching the term of the loan. Following a rate lock the process moves to block 520 where the loan terms, including amortization schedules, amounts, profits, and other relevant terms are finalized for the term of the loan.

Using the determined mortgage loan, and respective note terms, as determined at 520, the loan is closed/funded to borrower at block 521, and the first mortgage is received and held by lender. The borrower will receive the full loan proceeds at a term equal to that of the senior note and an amortization schedule that is, in some way, shorter than the senior note but longer than the remaining Hyper-Note(s). The senior note is then offered via processes that occur in block 526 to senior loan lenders as collateral to contribute with their pools of senior first mortgage loans in CMBS or CDO securities. Simultaneously, preceding, or following the sale of the senior note at block 526, the Hyper-Note(s) will be sold, held, or bundled with other Hyper-Notes to be sold or contributed as collateral to a security under processes that occur in block 524.

The first mortgage loan payment is paid by the borrower as a fixed payment every month. The senior note will receive a priority of payment which is smaller than the whole first mortgage loan payment because: a) by definition a senior note is evidence of a junior note such that the senior note size must then be smaller than the first mortgage loan; b) as described herein according to described systems and methods the senior note, in every case, must receive less than its prorated portion of amortization relative to the first mortgage loan (because, in all cases, the Hyper-Note amortizes more rapidly than the senior note); and c) due to the senior/subordinated nature of the priority of payment note structure, inherent to the herein described systems and methods, the senior note carries less risk than either the Hyper-Note or the entire first mortgage and, as such, receives a lower interest rate, as an illustrative operation, than either the subordinated Hyper-Note or the whole first mortgage loan's rate of interest. The debt service payment schedule for a Hyper-Note consists of all of the debt service payment paid from the borrower on the whole first mortgage loan minus all of the debt service payment due to the holder/owner of the senior note. The Hyper-Note payments may be customized however, because the whole first mortgage loan and the senior note are typically paid on a fixed schedule, the payments to the Hyper-Note(s) is often fixed and regular (i.e. monthly). If there are additional junior subordinated notes those notes are paid according to a distribution of the remaining cash flow, that may have a seniority of payment or may be paid pro-rata, after the first mortgage payment from the borrower has satisfied the senior note's required debt service. Additionally all funds from the mortgage payment that are not allocated to any note are retained by the debt servicing firm. Processing then terminates at block 528.

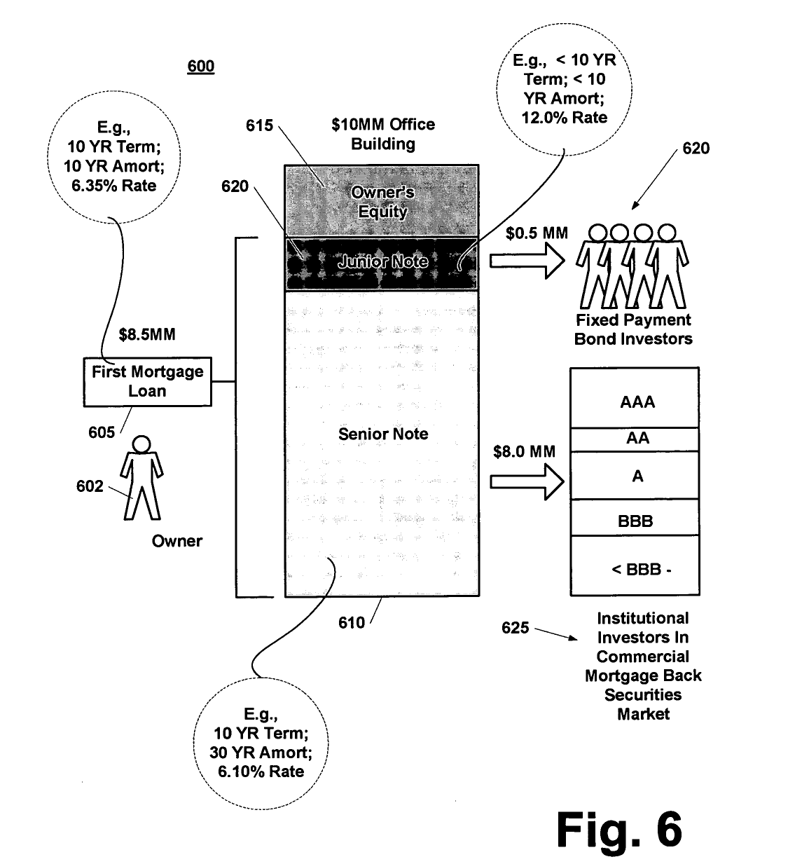

FIG. 6 shows a block diagram that is offered as a graphical representation of both, an office building and a vertical capital stack of a typical loan construct according the herein described systems and methods. The loan construction environment 600 comprises owner 602 receiving a loan in the amount of $8.5 MM secured by first mortgage loan 605 for the purchase, or refinance, of an office building worth $10 MM. The left side of the diagram can be thought of from the perspective of the borrower, or owner, as a single $8.5 MM whole loan with a single interest rate and mortgage payment with a 10 year term and a 26 year amortization schedule. The right side of the figure shows the loan construct as described herein. According to an exemplary loan constructed according to the herein described systems and methods, the $8.5 MM loan 605 can be structured so that it is represented by a senior note 610 having a loan value of $8.0 MM with a 10 year term and a 30 year amortization schedule and a subordinated Hyper-Note 620 having a loan value of $0.5 MM that self-liquidates before 10 years time (i.e. 118 months). The remaining portion of the $10.0 MM property, whether retained or required for purchase, is contributed by the owner as equity 615.

In an illustrative implementation the $8.0 MM senior promissory note is demonstrated to be sold to institutional investors in the commercial mortgage backed securities market (“CMBS”). CMBS is an efficient vehicle for pooling large quantities of congruous senior mortgage loans, or notes, for institutional investors. The lettered waterfall box shown in the FIG. 625 is a graphical representation of how CMBS investment pools of hundreds of mortgage loans, or senior notes, are horizontally carved up into subordinated bonds. The fixed payment bond investors 620 are shown to receive the $0.5 MM junior promissory note (“Hyper-Note”).

The first mortgage can be constructed such that the Hyper-Note is carved out of the whole loan as a by-product of a constructed market-standard senior “A-Note”. As an illustrative implementation the construct requires that the whole loan have a amortization schedule shorter (i.e. 26 years) than the senior note (i.e. 30 years), whereby the Hyper-Note is sized to such an amount as to allow it to self-amortize (i.e. over 118 months) by the difference in the mortgage loan payment on the entire loan, paid by the borrower (left side of figure), and the mortgage loan payment owed to the senior note (i.e. first mortgage loan payment=senior note payment+Hyper-Note(s) payment). The loan terms, and inset note terms, may vary widely but the senior note's loan balance and maturity (i.e. 10 years) and the whole loan's balance and maturity (i.e. 10 years) must be equal and commensurate.

In the illustrative implementation, owner 602 of the exemplary office building can receive financing on the property with a loan that is larger than is typically available with conventional loans. In an illustrative implementation the loan proceeds can be allocated to either repay existing financing or to contribute towards the building's acquisition.

The exemplary loan of FIG. 6 can allow an interested purchaser of the above office building to buy the building without having to put as much investment equity at risk. This by-product of the loan construct can allow a greater number of real estate entrepreneurs to purchase more and larger properties by allowing them greater purchasing power. As an example, a buyer is purchasing an office building for $10 million and has received numerous loan offers to provide him with an $8.0 million—single note only—first mortgage loan that amortizes over 30 years, at a more inexpensive interest rate of 6.10%. If the buyer were to accept such an offer s/he would have to raise $2.0 million of her own money to combine with the $8.0 million mortgage loan to pay the seller his $10.0 million purchase price. In contrast, the illustrative loan of FIG. 6 constructed in accordance with the herein described systems and methods can allow for an $8.5 million mortgage loan (in accordance with the illustrative implementation of FIG. 6, the amortization schedule for the higher loan amount can be selected such to allow for repayment of the Hyper-Note prior to the expiration of the senior note term). In this example, the buyer is afforded the opportunity to purchase the property with only $1.5 million of her own money and the additional $500,000 in loan proceeds is paid off over the loan maturity term with the higher debt payments—i.e., additional amortization (26 year amortization schedule vs. 30 years). Therefore, the creation of the exemplary loan structure not only allows for existing owners of properties to extract cash that they otherwise would not be able to take from their property to be used in new businesses but it also facilitates acquisitions that otherwise might not occur.

The benefits of the larger loan to owners and entrepreneurs notwithstanding, the two, or more, fixed income Hyper-Notes that are a byproduct of the herein described systems and measures can create value for investors in distinctly different markets—i.e., the long term CMBS institutional investing market 625 and the short term fixed income high yield bond market 620.

### Exemplary Amortization, Payment and Cash Flow:

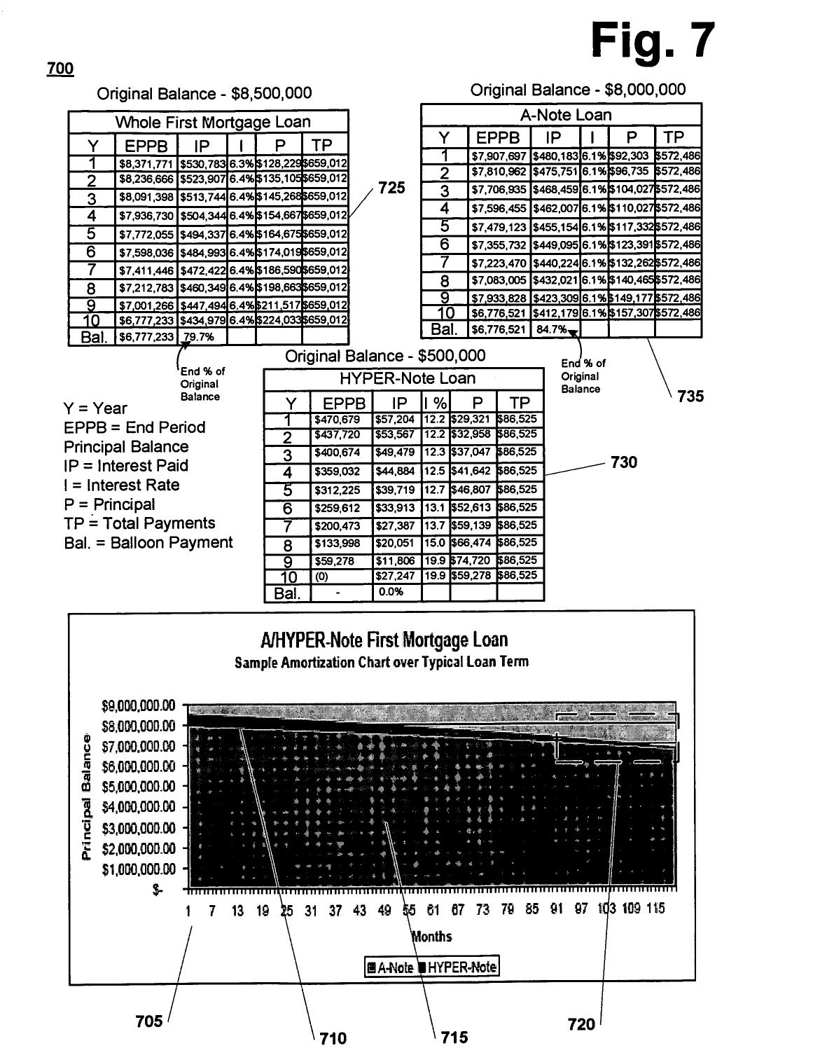

FIG. 7 illustrates three tables with annual loan balance and payment data demonstrating an exemplary loan under the herein described loan construct. The purpose is to demonstrate that the unequal parts do add up to match the whole in both payment, loan balance, and interest returns.

The whole first mortgage loan table 725 illustrates a market normal 10 year loan that amortizes over 26 years. The $8.5 million initial loan is paid down each year to the ending principal loan balance as illustrated under the “EPPB” column and results in a loan balance of $6,777,233 that must be repaid at the end of the 10 year loan term. Like every other long term fixed rate first mortgage the loan payments are equal and constant, paid $54,917.65 every month ($659,012 each year) over the loans term. The interest charged under this exemplary loan construct is 6.20% and has a loan mortgage constant of 7.75%. The first mortgage loan balance over the loan term is graphically depicted in chart 705 by the combination of the A-Note in blue 715 and the Hyper-Note in red 710.

The A-Note 735, senior promissory note, table illustrates another market normal 10 year loan that amortizes over 30 years. The smaller $8.0 million loan is paid down each year to the ending principal loan balance as also illustrated under the “EPPB” column to $6,776,521 by the end of the 10 year loan maturity date. The A-Note receives a fixed monthly payment of $47,707.18 ($572,486 per year) to service the loan. The debt service to the A-Note is paid from the whole first mortgage loan payment made by the borrower every month. The interest paid to the A-Note is 5.95% and the loan has a mortgage constant of 7.16%. The size of the senior A-Note and the interest paid to this exemplary promissory note is consistent in required profit, structure, and size with typical mortgages pooled into capital markets securitizations often described as Commercial Mortgage Backed Securitization “conduit” pools. Chart 705 effectively demonstrates how the A-Note is repaid in the blue section 715.

Table 730 depicts the resulting notable Hyper-Note loan(s) that makes up the difference in loan proceeds between the whole first mortgage loan and the A-Note and receives the difference in payments. Because both the whole first mortgage loan and the A-Note are fixed payments so too is the Hyper-Note(s), though this does not necessarily have to be the case, receiving $7,210.47 per month ($86,525 per year) as service of interest and principal to this junior promissory note. As the annual ending period principal schedule depicts (column under “EPPB”) the Hyper-Note is paid off in full prior to the loan's 10 year maturity date. In fact it is paid off, in the illustrated exemplary loan construct after the 117^{th} loan payment. The Hyper-Note receives an 11.75% rate of interest with the remainder of each note payment going to pay down the principal balance. The initial mortgage constant is 17.3%. It is expected, but not required, that the Hyper-Notes will be repaid in full prior to the loan term. As chart 705 graphically demonstrates, the Hyper-Note in red 710 is rapidly repaid over the 10 year term, must faster than either the A-Note or the whole first mortgage loan—which is simply the combination of the A-Note 715 and the Hyper-Note 710. The Hyper-Note is completely paid off as is shown at 720 and this is where the A-Note and the whole first mortgage loan become equivalent in size and risk characteristics. The obvious benefit to the borrower and the A-Note holder is that the refinance ability of the non-market standard $8.5 million loan is ultimately no different than it would have been if the borrower had received a market standard $8.0 million.

Often, as in this exemplary illustration of the herein described loan construct, there will be some nominal residual cash flow, as in this example resulting from the remaining 118^{th}, 119^{th}, and 120^{th} payments due to the Hyper-Note (totaling $21,631.41). These highly predictable monies can be used to firstly match the maturity loan balances between the A-Note and the whole first mortgage loan. In the example provided 700 this is not required because the borrower is expected to repay a loan ($6,777,233) greater than the A-Note requires her to repay ($6,776,521), therefore in addition to the $21,631 surplus from residual Hyper-Note payment there will be an additional payment of $712 paid by the borrower upon the loans maturity. Secondarily these surplus monies may be sold to investors, as is often done in the capital markets and termed as “interest only strips”. Or they may be pledged to either the A-Note holder or the borrower as excess collateral to ensure a better reception from investors who may be wary about the impact of a novel Hyper-Note structure to their A-Note investment.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods. This includes, but is not limited by, a loans term maturity and the length of amortization of any component part of the loan construct herein described.

It should also be noted that the herein described systems and methods can be implemented in a variety of electronic environments (including both non-wireless and wireless computer environments), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A system for constructing loans comprising:
a data store comprising one or more of loan parameter data and mortgage amortization schedule data; and
a loan construction engine operable on the data store to construct a loan using one or more of the loan parameter data and mortgage loan amortization schedule data according to a selected loan construction paradigm,
wherein the selected loan construction paradigm allows for a single first mortgage loan to be bifurcated into at least two promissory notes such that each of the at least two promissory notes have an identical loan term maturity, excepting any junior note(s) which may be repaid in full before the loan term of the first mortgage loan and senior note, and disparate amortization schedules with each other and with the underlying first mortgage loan,
wherein the amortization schedule of the selected loan construction paradigm requires that the first mortgage loan have a shorter amortization schedule than the senior promissory note but a longer amortization schedule than the junior promissory note(s).
wherein the at least two promissory notes have an association according to their respective amortization schedules such that one of the at least two notes is paid down to zero, or to a materially small amount, before the term maturity of the first mortgage loan and of the at least two promissory notes expires.

2. The system as recited in claim 1 wherein the loan construction engine comprises a computing application executing in a computing environment.

3. The system as recited in claim 2 wherein the computing environment is a networked computing environment.

4. The system as recited in claim 1 wherein the loan construction paradigm allows for the creation of a first mortgage loan that may be divided into a senior promissory note and one or more junior promissory note(s) each having a differing amortization schedule,
wherein excess debt service, after service to a senior note with a longer amortization schedule, as primarily derived from the shorter amortization schedule that is collected by the first mortgage loan, is used to repay principal and/or interest on the junior note.

5. The system as recited in claim 4 wherein the senior note amortization schedule is set to market accepted normal ranges, which may include periods of interest only payments.
Wherein the overlying first mortgage loan has a matching amortization schedule to the senior note and the junior promissory note is self-amortized by loan maturity from amortization paid to the first mortgage loan during the period of interest only under the senior note.

6. The system as recited in claim 1 further comprising a data store comprising data representative of one or more amortization schedules.

7. The system as recited in claim 1 further comprising a communications network operable to allow the loan construction engine to electronically communicate with one or more other cooperating computing environments.

8. The system as recited in claim 7 wherein the one or more other cooperating computing environments comprise any of lender computing environments and investor computing environments.

9. The system as recited in claim 1 further comprising a first mortgage loan representative of an unsubordinated security interest in real property used to secure a loan.

10. The system as recited in claim 1 further comprising a data store comprising data representative of borrower information comprising any of credit worthiness, equity in real property, information about collateral, and financing statements.

11. A method to construct a loan comprising:
providing a first mortgage loan having a selected loan term maturity;
providing a bifurcated senior note to represent a portion of the loan with an identical term maturity as the first mortgage loan term maturity;
providing at least one second junior note to represent the remainder portion of the loan; and
selecting amortization schedules for the first mortgage loan, senior note, and the at least one junior note such that a portion of the funds received to repay the first mortgage loan are allocated to paying down the senior note according to a first selected market-standard amortization schedule and the remainder is allocated to paying interest and principal so that the at least one junior note is paid down to zero, or to a financially insignificant amount within the full loan term maturity of the first mortgage loan.

12. The method as recited in claim 11 further comprising providing for a first mortgage loan that is higher than standard market accepted normal ranges.

13. The method as recited in claim 12 further comprising providing for a bifurcated first mortgage loan to include a senior note to represent a portion of the loan that is generally within standard market accepted normal ranges.

14. The method as recited in claim 12 further comprising calculating cash flows for the first mortgage loan, the senior note, and the at least one junior note.

15. The method as recited in claim 11 further comprising selecting a whole loan amortization schedule representative of the amortization schedule of a market standard combined first mortgage loan.

16. The method as recited in claim 15 further comprising selecting a second amortization schedule representative of the market standard amortization schedule of the senior note.

17. The method as recited in claim 16 further comprising selecting a third amortization schedule representative of the novel amortization schedule of the at least one junior note.

18. The method as recited in claim 17 further comprising selecting a term for the loan.

19. The method as recited in claim 18 further comprising selecting the whole loan, second, and third amortization schedules using as a reference the loan term such that the whole loan amortization schedule is shorter than the second amortization schedule and longer that the third amortization schedule.

20. A computer readable medium having computer readable instructions to instruct a computer to perform a method comprising:
providing a first mortgage loan having a selected loan term;
providing a bifurcated senior note to represent a portion of the loan;
providing at least one second junior note to represent the remainder portion of the loan; and
selecting amortization schedules for the first mortgage loan, senior note, and the at least one junior note such that a portion of the funds received to repay the first mortgage loan are allocated to paying down the senior note according to a second selected amortization schedule and so that the at least one junior note is paid down to zero, or a financially insignificant amount, within the full loan term of the first mortgage.
